(19) United States
(12) Patent Application Publication
(10) Pub. No.: US 2013/0119638 A1
(43) Pub. Date: May 16, 2013

(54) Pintle Ring Converted to a Ball Receiver

(71) Applicant: Ronald O. FIELDS, Cloudcroft, NM (US)

(72) Inventor: Ronald O. FIELDS, Cloudcroft, NM (US)

(21) Appl. No.: 13/294,925

(22) Filed: Nov. 11, 2011

(51) Int. Cl. B60D 1/07

(52) U.S. Cl. 280/416.1

(57) ABSTRACT

A pintle ring converted to a ball receiver comprises of a top half, a bottom half, a ball receiver coupler, a bolt connecting mechanism, and a locking mechanism. The bolt connecting mechanism comprises of a threaded connecting bolt and a lock washer. The top half comprises of a top sculpted flange, a top weep hole, a top center hole, and a top flat edge. The bottom half comprises of a bottom neck, a bottom threaded center hole, and a bottom flat edge. The ball receiver coupler comprises of a lock bolt hole. The locking mechanism comprises of a locking bolt and a snap-in cotter key. The locking bolt comprises of a cotter key hole, a straight end, and a bent end.

The current application claims a priority to the U.S. Provisional Patent application Ser. No. 61/411,133 filed on Nov. 8, 2010.

### FIELD OF THE INVENTION

The present invention relates generally to an apparatus for connecting a trailer to a vehicle. More particularly, the present invention is an apparatus that converts a pintle ring coupler to a ball coupler for a ball style hitch.

### BACKGROUND OF THE INVENTION

The conventional pintle ring (also known as the Lunette ring) trailer coupler is used on many trailers, specifically heavy duty ones, because of its ability to carry heavy loads. The two and a half inch inside diameter pintle ring carry loads up to 30,000 lbs. The three inch inner diameter pintle rings carry loads up to 90,000 lbs. By design, the pintle ring is loose fitting when connected to the pintle hook on the tow vehicle trailer hitch. The loose fit design can cause the pintle ring and pintle hook to be excessively noisy when in motion because the two parts come constantly into contact with each other when driving at differing speeds and in various road conditions. This loud impact noise, which is a result of the pintle ring and hook's changes in position, causes the occupants in the tow vehicle and the surrounding traffic to be distracted, which is dangerous in moving traffic. This noise is worst in start and stop traffic as the trailer lunges forward or backward to close the gap in the pintle ring and pintle hook, even in normal driving conditions. This is also the case on rough roads, or when turning in either direction. The changing slope or incline of the road will also cause the pintle ring and hook connection to move and create impact noise.

Many people that haul trailers are not equipped to connect to the pintle ring coupler. The pintle ring is not as commonly used as a ball receiver coupler. Therefore, with a device that can change the pintle ring to a ball receiver coupler, the towing vehicle can be used for differing sizes of pintle ring equipped trailers on ball equipped hitches. The present invention, herein referred to as the pintle mate, will give the towing vehicle a greater flexibility to haul different trailers equipped with different couplers with only a ball equipped vehicle hitch and will make this conversion from pintle ring to a ball coupler quick and easy.

### SUMMARY OF THE INVENTION

Pintle ring couplers are made in two common sizes, two and a half inch and three inch inside diameter pintle ring couplers. The present invention, referred to as the pintle mate, is a quick, simple, and convenient way to move pintle ring equipped trailers without adding the pintle hook on the tow vehicle trailer hitch. The present invention is made of cast steel and allows the pintle ring to be converted to a ball receiver on the trailer. The pintle mate is made of two separated halves, a bolt connecting mechanism, and a hitch ball locking mechanism. One of the two major part mounts on top of the pintle ring and has a three inch flange made to fit inside a three inch inner diameter pintle ring. This top part can be turned over with the flange up for connecting the pintle mate to a two and a half inch inner diameter pintle ring. The lower half of the two major halves has a two and a half inch neck that always goes from the bottom up into the pintle ring no matter which size pintle ring is being used. Below this neck of the pintle mate is a hitch ball receiver with securing mechanisms.

When the two halves of the pintle mate are put in place and secured into either size of pintle ring with a threaded bolt, the pintle mate is converted for usage on a hitch ball. With the pintle mate in place and the bolt tightened, the trailer can now be attached to a towing vehicle equipped with a correctly sized hitch ball.

A bolt is inserted through a hole that traverses through the ball receiver coupler (below the ball) to prevent the pintle mate from detaching from the hitch ball while in transit. A snap-in cotter key is inserted into the end of the bolt to prevent this security bolt from working out while in transit.

With the present invention, the pintle ring coupler can be converted to a standard hitch ball receiver for connection to a vehicle with ball type trailer hitch. This conversion is quickly installed through and on the pintle ring and makes a quiet connection and snug fit when used on any vehicle equipped with ball style hitch with a correctly sized ball.

### BRIEF DESCRIPTION OF THE DRAWINGS

FIG. 1 is a left-side view of the present invention on a two and a half inner diameter pintle ring.

FIG. 2 is a front plan view of the present invention on a two and a half inch inner diameter pintle ring.

FIG. 3 is a cross-sectional view of the present invention on a two and a half inner diameter pintle ring.

FIG. 4 is a perspective view of the present invention on a two and a half inner diameter pintle ring.

FIG. 5 is a left-side view of the present invention on a three inch inner diameter pintle ring.

FIG. 6 is a front plan view of the present invention on a three inch inner diameter pintle ring.

FIG. 7 is a perspective view of the present invention on a three inch inner diameter pintle ring.

FIG. 8 is a front plan view of the present invention on a pintle ring attached to a trailer.

### DETAIL DESCRIPTIONS OF THE INVENTION

All illustrations of the drawings are for the purpose of describing selected versions of the present invention and are not intended to limit the scope of the present invention.

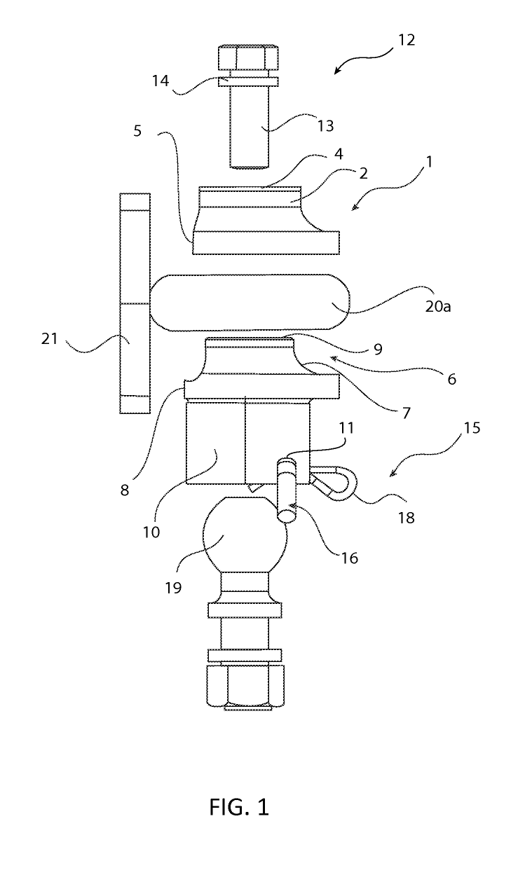

In reference to FIG. 1, the pintle mate consists of varying components. The two cast steel parts include the top half 1 and the bottom half 6 that attaches to and through a pintle ring 20 to maintain its position on the pintle ring 20. The pintle ring 20 is connected to a pintle ring base plate 21. At an end of the bottom half 6 is a ball receiver coupler 10 that covers and holds the hitch ball 19 in place. A bolt connecting mechanism 12 is used to lock the previously mentioned components together. Finally, a locking mechanism 15 is used to lock the hitch ball 19 in place. All components work in conjunction with each other to create a tight fitting of the pintle ring 20 and hitch ball 19.

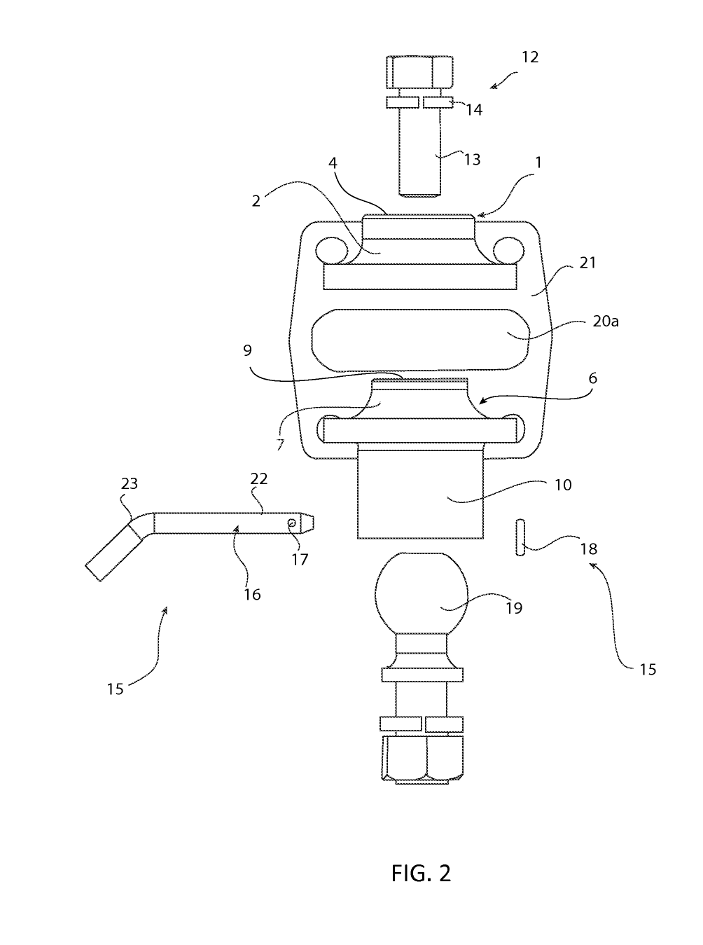

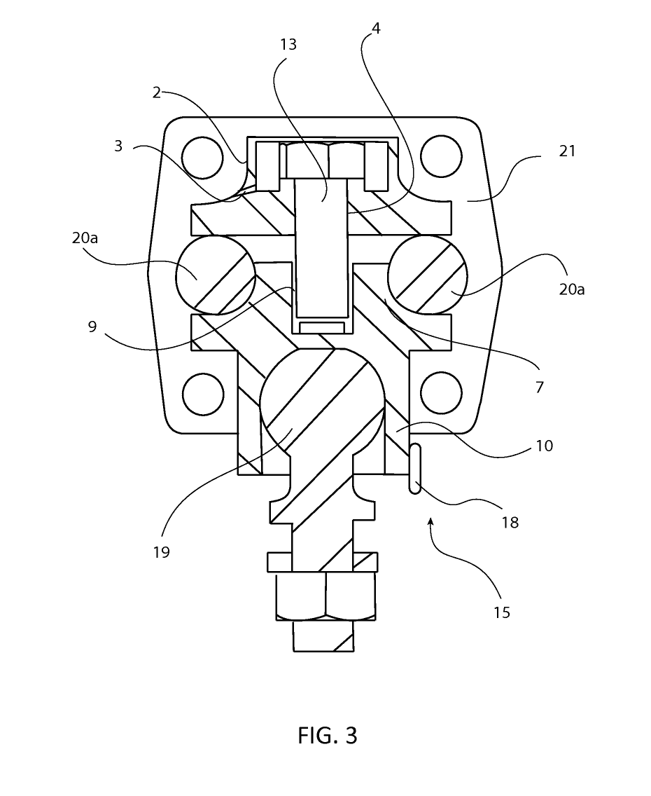

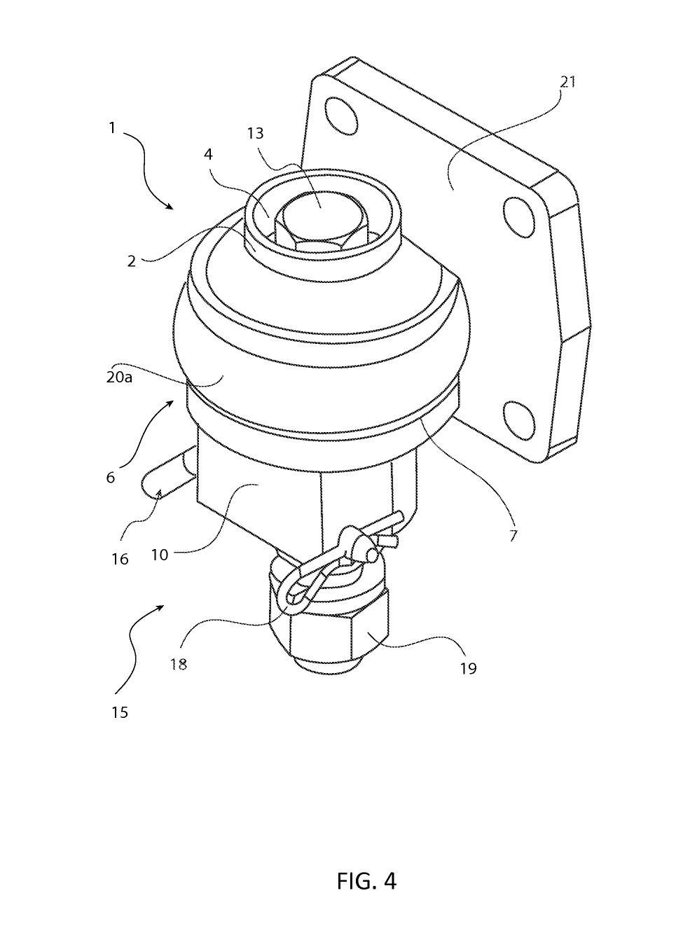

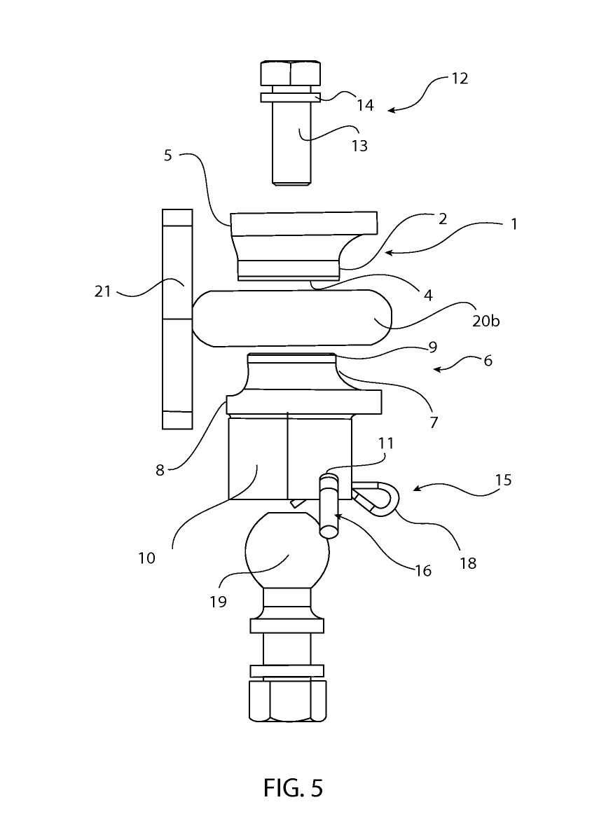

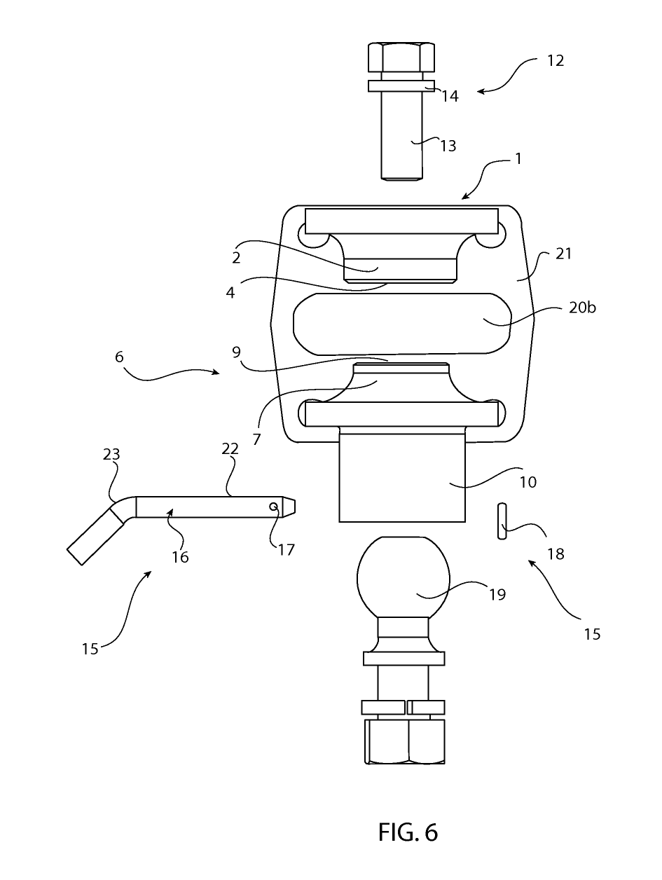

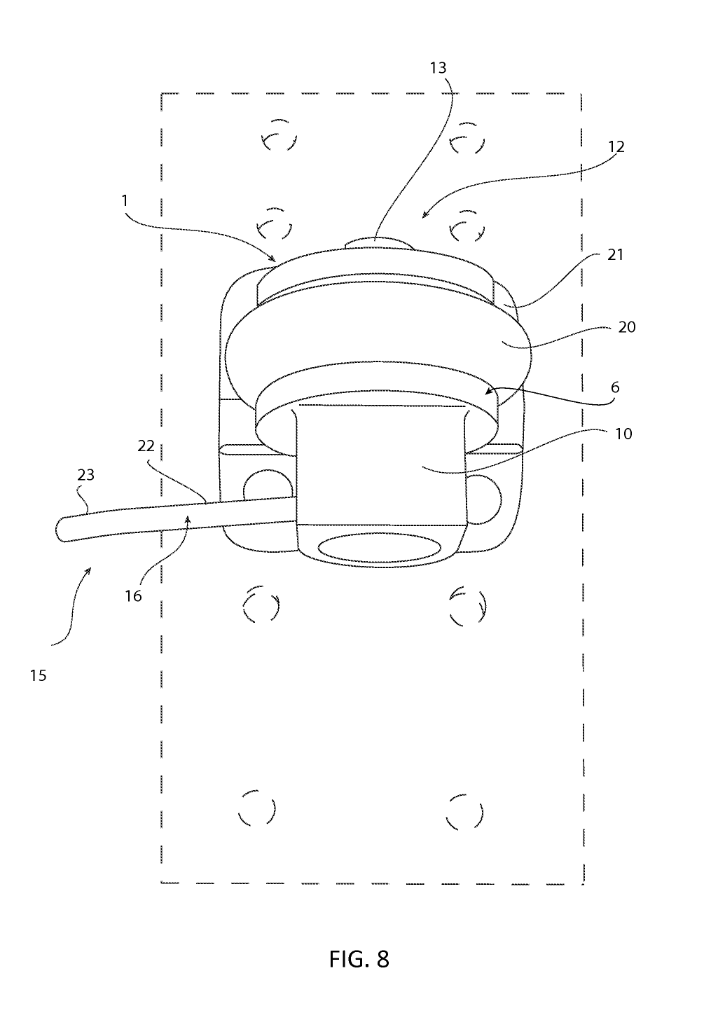

In reference to FIG. 1, FIG. 2, FIG. 3, FIG. 4, FIG. 5, FIG. 6, and FIG. 8, the pintle ring 20 is fixed between a top half 1 portion and a bottom half 6 portion of the pintle mate. They are designed to fit through the center of the pintle ring 20 for proper centering and alignment with the pintle ring 20 surfaces when installed. The top half 1 and the bottom half 6sculptured surfaces aid in maintaining the position of the pintle ring 20 to avoid unnecessary movement and noise. The top half 1 portion is comprised of a top sculpted flange 2, a top weep hole 3, a top center hole 4, and a top flat edge 5. On the other hand, the bottom half 6 portion is also comprised of a bottom sculpted neck 7, a bottom threaded center hole 9, and a bottom flat edge 8. Both the top flat edge 5 and the bottom flat edge 8 are designed to face the pintle ring base plate 21, which is the pintle connection point to the trailer on many pintle rings. This is because pintle rings 20 have a built up surface on the back of the ring 20 to make the ring attachment point stronger at its base plate 21 connection. Also, having both the top flat edge 5 and the bottom flat edge 8 facing the trailer (as well as at the back of the ring and the pintle ring base plate 21) will allow easy access for insertion of the bolt connecting mechanism 12. The top sculpted flange 2 has, but is not limited to, an inner diameter of two and a half inches and an outer diameter of three inches. The top center hole 4 allows the bolt connecting mechanism 12 to join the top half 1 of this invention to the bottom half 6 with the ball receiver coupler 10. The top half 1 can be connected with either the top flange 2 facing upwards or downwards, depending on the size of the pintle ring 20. By turning the top half 1 of the pintle mate “top flange 2 up” or “top flange 2 down” the pintle mate will fit the varying sizes of the pintle rings, namely the two and a half inch and three inch rings. Specifically, when the pintle mate is arranged “flange 2 up” it will fit a smaller (two and a half inch inner diameter) pintle ring 20a. Also, when the pintle mate is positioned “flange 2 down”, it will fit a larger (three inch inner diameter) pintle ring 20b.

In reference to FIG. 3, the top weep hole 3 in the top half 1 is located at the base of the top flange 2 to prevent water from accumulating inside the top flange 2 when it is used on a two and a half inch pintle ring 20a only. Since the apparatus will be used in an outside environment, it is important to limit the possibility of corrosion on the components of the pintle mate. With the advantage of the weep hole 3 on the two and half inch pintle ring, water will be bleed off through this weep hole 3 when the top flange 2 is up.

Referring to FIG. 1 and FIG. 3, the bottom half 6 of the pintle mate has a two and a half inch outside diameter neck 7 that always remains inside the pintle ring 20, regardless of the size of the actual ring 20. Unlike the top half 1, this component remains constant for any size and type of pintle ring 20. The neck 7 that rests inside the pintle ring 20 contains the bottom threaded hole 9 that allows the top 1 and bottom 6 halves of the pintle mate to be securely connected together with the bolt connecting mechanism 12. In doing so, the pintle ring 20 is tightened and secured in its position.

In reference to FIG. 1 and FIG. 2, the top 1 and bottom 6 halves are aligned together so the bolt connecting mechanism 12 passing through the top center hole 4 will be aligned with the bottom center hole 9 which is inside the pintle ring 20. If a two and a half inch inner diameter pintle ring 20a is being used, the top half 1 will not self align. However, the top half 1 can quickly be moved into an alignment position on the two and a half inch inner diameter pintle ring 20a.

In reference to FIG. 1, FIG. 2, and FIG. 3, in the present invention, the connecting mechanism 12 comprises of a threaded connecting bolt 13 and a lock washer 14. The threaded bolt 13 passes through the top center hole 4 of the top half 1 portion of the pintle mate then into the bottom threaded hole 9 and is screwed into the bottom half 6. The threaded bolt 13 is then tightened with the lock washer 14 to secure the two halves together. The bottom half 6 portion of this pintle mate has an attached ball receiver coupler 10 that can be fabricated to accommodate any size of hitch ball. The ball receiver coupler 10 keeps the hitch ball 19 in place so there is little chance that it will come loose. There is a lock bolt hole lion an open end of the ball receiver coupler 10 at the base that is opposite the neck at the base of the ball receiver 10. The lock bolt hole 11 is where a locking mechanism 15 can be inserted to secure the towing vehicle ball to the pintle mate for towing.

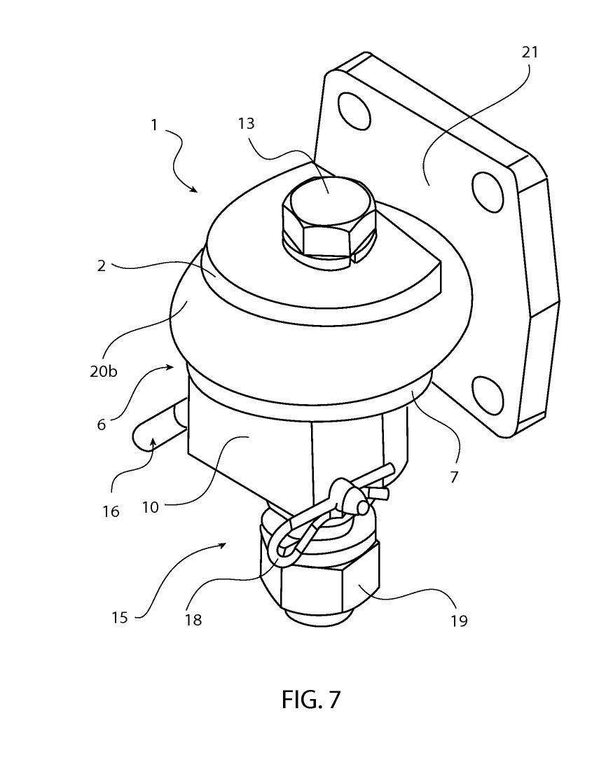

In reference to FIG. 1, FIG. 2, FIG. 4, FIG. 5, FIG. 7, and FIG. 8, the locking mechanism 15 includes a hitch ball locking bolt 16 and a snap-in cotter key 18. The hitch ball locking bolt 16 passes through the lock bolt hole 11, which is located on the ball receiver coupler 10, and below the hitch ball 19 of the towing vehicle after the hitch ball 19 is connected to the pintle mate. The hitch ball locking bolt 16 is kept in place with the snap-in cotter key 18. To ensure that the connection is secure, a snap-in cotter key 18 slides into a small cotter key hole 17 located on a straight end 22 of the locking bolt 16 that protrudes out of the ball receiver coupler 10 after the locking bolt 16 is fully inserted. The other end of the locking bolt is a bent end 23, and is what allows the bolt 16 to stay securely in its position. A tight torque fit of the top and bottom components of the pintle mate will create a more secure attachment and less possibility of movement.

In reference to FIG. 4, FIG. 5, and FIG. 7 a goal of the present invention is designed to convert a pintle ring 20 to a ball type coupler for ball style trailer hitches. The versatility of the ball receiver 10 allows the present invention to attach to both the two and a half inch 20a and three inch inner diameter 20b pintle rings. The portion of the ball receiver coupler 10 that is inside the pintle ring 20 is designed to form fit with the two and a half inch outer diameter when inserted into the two and a half inch inner diameter pintle ring 20a with the ball receiver 10 down. The portion of the bottom half 6 that is inserted into the pintle ring 20 is the portion that has the bottom threaded hole 9 in the center. The size of this hole 9 is, but not limited to one inch. Again, the versatility of the bottom half 6 is that it can be used for both common sizes of pintle rings.

In reference to FIG. 5 FIG. 6, and FIG. 7 to connect the pintle mate to the three inch inner diameter pintle ring 20b, the top half flange 2 must be in its “down” position to fit inside the pintle ring 20b. Also, when the top flange 2 is down, it covers the two and a half inch outer diameter of the bottom neck 7 above the ball receiver 10 that is inserted up into the pintle ring 20b from the bottom 6. The close fit that is created around the pintle ring 20b by the two halves provides a movement free attachment of pintle rings when secured with the threaded bolt 13. With the pintle mate secured to the pintle ring 20 (regardless of its size) it can be attached to any correctly sized ball with ease. The pintle mate is presently cast to fit a two and five-sixteenths inch ball. However, the design is not limited to this size ball. It can be made to fit any and all sizes of hitch balls.

In reference to FIG. 1, FIG. 4, FIG. 5, and FIG. 7, an important part of the pintle mate design is its ability to fit most pintle rings. Some styles of a three inch pintle ring 20b have a large slope up and down surface where the pintle ring 20b connects to the base plate 21, which mounts onto the trailer. Other styles of pintle rings do not have this sloping ring surface at the mounting base connection point and the position of the top flat edge 5 and bottom flat edge 8 is not important when the pintle mate is attached to them. However, the orientation of the top flat edge 5 and the bottom flat edge 8 of this invention become important since pintle mate will not fit the slope up and down surface style pintle ring 20 if the top flat edge 5 and the bottom flat edge 8 are not facing the trailer pintle ring mounting base plate 21.

There are several advantages to the pintle mate. The existing pintle ring and pintle hook design allows for movement at the contact point between the towing vehicle and the trailer. The contact between the towing vehicle and the trailer, as a result of the loose fitting pintle ring and pintle hook design, causes a great deal of impact noise. The towed trailer by design moves around on the smaller poor fitting pintle hook and pintle ring connection. The trailer moves and impacts the hook on the towing vehicle as speed and road conditions change. The pintle mate eliminates the impact at the connection point by changing the pintle ring into a ball type coupling and eliminating the noise between pintle ring and pintle hook, because the pintle hook is no longer needed. This pintle mate also makes it easy to adapt any pintle ring equipped trailer of different size pintle rings to a standard ball hitch coupler. Another advantage of this system is the elimination of the wear between the pintle ring and hook. Currently, when the pintle ring and pintle hook impact each other, the friction between the two surfaces begin to breakdown the surface material. This breakdown of material can lead to eventual failure of the pintle ring and pintle hook combination. Having a pintle mate, the need for a pintle hook hitch becomes unnecessary unless the load of the vehicle exceeds the limits of the vehicle's hitch or hitch ball.

In reference to FIG. 4 and FIG. 7, another unique advantage of this invention is that it will eliminate all the noise between the pintle ring and pintle hook. Current pintle hook assemblies allow for extreme jarring and shock to drivers and passengers when a vehicle is put in motion or braking This type of movement causes the pintle ring and pintle hook to slam against each other so hard that excessive noise is created and is very distracting, this is also true of rapid acceleration. The same is true when rough roads or curves in the road are encountered as the pintle ring can move side to side, front to back and up and down inside the pintle hook. When the pintle mate is in use, there is little or no wear on the hitch ball attachment point. The secure attachment that is created between the ball receiver coupler 10 and the hitch ball 19 by the locking mechanism 15 is essential to holding the apparatus together to ensure minimal movement of pintle ring 20 and hitch ball 19 while the vehicle is in motion.

The pintle mate has a unique design and gives the user the convenience of converting a pintle ring to a ball receiver. It only requires one pintle mate to convert the two previously mentioned common size pintle rings (two and a half inch and three inch) to a ball type coupler. With this design other sizes of pintle mates can be made to fit other sizes of pintle rings as needed.

Although the invention has been explained in relation to its preferred embodiment, it is to be understood that many other possible modifications and variations can be made without departing from the spirit and scope of the invention as hereinafter claimed.

What is claimed is:

1. A pintle ring converted to a ball receiver comprises,
a top half;
a bottom half;
a ball receiver coupler;
a bolt connecting mechanism;
a locking mechanism;
the top half being attached to the bottom half;
the bolt connecting mechanism securing the top half to the bottom half;
the ball receiver coupler being attached to the bottom half, opposite of the top half; and
the locking mechanism being secured onto the ball receiver coupler.

2. The pintle ring converted to a ball receiver, as claimed in claim 1 comprises,
the bolt connecting mechanism comprises of a threaded connecting bolt and a lock washer;
the top half and the bottom half being attached with a threaded connecting bolt;
the top half and the bottom half being secured to the threaded connecting bolt with a lock washer;
the top half comprises of a top sculpted flange, a top weep hole, a top center hole, and a top flat edge;
the bottom half comprises of a bottom neck, a bottom threaded center hole, and a bottom flat edge; and
the ball receiver coupler comprises of a lock bolt hole.

3. The pintle ring converted to a ball receiver, as claimed in claim 1 comprises,
the locking mechanism comprises of a locking bolt and a snap-in cotter key.

4. The pintle ring converted to a ball receiver, as claimed in claim 2 comprises,
the top sculpted flange being positioned upwards;
the top center hole traversing through the top half;
the top weep hole traversing through the top sculpted flange;
the bottom neck being positioned atop the bottom half;
the bottom threaded center hole traversing into the bottom half;
the top flat edge being aligned with the bottom flat edge;
the top center hole being aligned with the bottom threaded center hole;
the lock bolt hole being positioned near an open end of the ball receiver coupler; and
the locking mechanism sliding through the lock bolt hole.

5. The pintle ring converted to a ball receiver, as claimed in claim 3 comprises,
the locking bolt traversing through the lock bolt hole;
the locking bolt comprises of a cotter key hole, a straight end, and a bent end;
the bent end being opposite of the straight end;
the cotter key hole traversing through the straight end;
the straight end traversing through the lock bolt hole; and
the snap-in cotter key being traversed through the cotter key hole.

6. A pintle ring converted to a ball receiver comprises,
a top half;
a bottom half;
a bolt connecting mechanism;
a ball receiver coupler;
a locking mechanism;
the top half being attached to the bottom half;
the bolt connecting mechanism securing the top half to the bottom half;
the ball receiver coupler being attached to the bottom half, opposite of the top half; and
the locking mechanism being secured onto the ball receiver coupler.

7. The pintle ring converted to a ball receiver, as claimed in claim 6 comprises,
the bolt connecting mechanism comprises of a threaded connecting bolt and a lock washer;
the top half and the bottom half being attached with a threaded connecting bolt;
the top half and the bottom half being secured to the threaded connecting bolt with a lock washer;
the top half comprises of top sculpted flange, a top center hole, and a top flat edge;
the bottom half comprises of a bottom neck, a bottom threaded center hole, and a bottom flat edge; and
the ball receiver coupler comprises of a lock bolt hole.

8. The pintle ring converted to a ball receiver, as claimed in claim 6 comprises.
the locking mechanism comprises of a locking bolt and a snap-in cotter key.

9. The pintle ring converted to a ball receiver, as claimed in claim 7 comprises,
the top sculpted flange being positioned downwards;
the top center hole traversing through the top half;
the bottom neck being positioned atop the bottom half;
the bottom threaded center hole traversing into the bottom half;
the top flat edge being aligned with the bottom flat edge;
the top center hole being aligned with the bottom threaded center hole;
the lock bolt hole being positioned near an open end of the ball receiver coupler; and
the locking mechanism sliding through the lock bolt hole.

10. The pintle ring converted to a ball receiver, as claimed in claim 8 comprises,
the locking bolt traversing through the lock bolt hole;
the locking bolt comprises of a cotter key hole, a straight end, and a bent end;
the bent end being opposite of the straight end;
the cotter key hole traversing through the straight end;
the straight end traversing through the lock bolt hole; and
the snap-in cotter key being traversed through the cotter key hole.

11. A pintle ring converted to a ball receiver comprises,
a top half;
a bottom half;
a ball receiver coupler;
a bolt connecting mechanism;
a locking mechanism;
the top half being attached to the bottom half;
the bolt connecting mechanism securing the top half to the bottom half;
the ball receiver coupler being attached to the bottom half, opposite of the top half; and
the locking mechanism being secured onto the ball receiver coupler.

12. The pintle ring converted to a ball receiver, as claimed in claim 11 comprises,
the bolt connecting mechanism comprises of a threaded connecting bolt and a lock washer;
the top half and the bottom half being attached with a threaded connecting bolt;
the top half and the bottom half being secured to the threaded connecting bolt with a lock washer;
the top half comprises of a top sculpted flange, a top weep hole, a top center hole, and a top flat edge;
the bottom half comprises of a bottom neck, a bottom threaded center hole, and a bottom flat edge;
the ball receiver coupler comprises of a lock bolt hole; and
the locking mechanism comprises of a locking bolt and a snap-in cotter key.

13. The pintle ring converted to a ball receiver, as claimed in claim 12 comprises,
the top sculpted flange being positioned upwards;
the top center hole traversing through the top half;
the top weep hole traversing through the top sculpted flange;
the bottom neck being positioned atop the bottom half;
the bottom threaded center hole traversing into the bottom half;
the top flat edge being aligned with the bottom flat edge;
the top center hole being aligned with the bottom threaded center hole;
the lock bolt hole being positioned near an open end of the ball receiver coupler; and
the locking mechanism sliding through the lock bolt hole.

14. The pintle ring converted to a ball receiver, as claimed in claim 12 comprises,
the locking bolt traversing through the lock bolt hole;
the locking bolt comprises of a cotter key hole, a straight end, and a bent end;
the bent end being opposite of the straight end;
the cotter key hole traversing through the straight end;
the straight end traversing through the lock bolt hole; and
the snap-in cotter key being traversed through the cotter key hole.
